(19) United States
(12) Patent Application Publication
(10) Pub. No.: US 2025/0361145 A1
(43) Pub. Date: Nov. 27, 2025

(54) SYNTHESIS OF NANOSTRUCTURED ZIRCONIUM PHOSPHATE

(71) Applicant: Evonik Operations GmbH, Essen (DE)

(72) Inventors: Franz Schmidt, Gross-Gerau (DE); Durdu Schäfer, Rodgau (DE); Armin Wiegand, Grosskrotzenburg (DE); Nico Heindl, Rodenbach (DE); Ryo Takata, Shanghai (CN); Daniel Esken, Erlensee (DE); Marcel Herzog, Karlstein (DE)

(73) Assignee: Evonik Operations GmbH, Essen (DE)

(21) Appl. No.: 18/874,472

(22) PCT Filed: Jun. 29, 2023
(86) PCT No.: PCT/EP2023/067891

§ 371 Date: Dec. 12, 2024

(30) Foreign Application Priority Data
Jul. 7, 2022 (EP) 22183525.9

(51) Int. Cl. C01B 25/42; H01M 4/58; H01M 10/0525

(52) U.S. Cl. CPC C01B 25/42; H01M 4/5825; H01M 10/0525; C01P 2004/50; C01P 2006/11; C01P 2006/12; C01P 2006/40

(57) ABSTRACT

A process produces zirconium phosphate by flame spray pyrolysis. A solution of at least one zirconium compound, an organic phosphate and a solvent with less than 10% by weight water is subjected to flame spray pyrolysis. Zirconium phosphate obtainable by this process finds application in batteries to encapsulate lithium mixed oxide particles.

### FIELD OF THE INVENTION

The invention relates to a process for producing zirconium phosphate by means of flame spray pyrolysis, zirconium phosphate obtainable by this process and the use thereof in batteries especially to encapsulate lithium mixed oxide particles.

### PRIOR ART

Secondary lithium ion batteries are one of the most important battery types currently used. The secondary lithium ion batteries are usually composed of an anode made of a carbon material or a lithium-metal alloy, a cathode made of a lithium-metal oxide, an electrolyte in which a lithium salt is dissolved in an organic solvent and a separator providing the passage of lithium ions between the positive and the negative electrode during the charging and the discharging processes.

In endeavour to develop secondary batteries with improved intrinsic safety and energy density, the use of solid instead of liquid electrolytes has considerably progressed in the recent time. Among such systems, secondary lithium batteries with electrodes made of lithium metal or lithium metal alloys are believed to provide high energy density and be particularly suitable. Such all-solid-state secondary lithium ion batteries should have good ion conductivity at an interface between an electrode active material and an electrolyte in order to have the required load characteristics. This high ion conductivity can be achieved by coating the surface of an active electrode material with some lithium-comprising compounds, such as LiTi₂(PO₄)₃, as described in JP 4982866 B2.

A major general problem with cathode materials is the aging and thus the loss of performance during cycling. This phenomenon is especially relevant for high Nickel-NMC. During cycling the positive electrode material suffers from several electrochemical degradation mechanisms. Surface transformations like the formation of a NiO-like phase due to the reduction of Ni⁴⁺ in a highly delithiated state and oxygen loss as well as transition metal rearrangement destabilizes the crystal structure. This phase transitions have been associated to initiate cracks in the cathode particles and subsequent particle disintegration. In addition, electrolyte decomposes at the reactive surface of NMC and electrolyte decomposition products deposit at the interface which leads to an increased resistance. Furthermore, the conducting salt LiPF₆, which is commonly used in liquid electrolytes reacts with the trace amounts of H₂O present in all commercial formulations to form HF. The formed acidic HF causes lattice distortion in the cathode material by dissolution of transition metal ions out of the surface of the cathode material into the electrolyte. All these degradation mechanisms result in a decrease of capacity, performance and cycle life. Surface coating of cathode active materials has proven to be an extremely important method to address this aging problem by suppressing the direct contact between the active materials surfaces and the liquid electrolyte.

WO 2021/089886 describes a process for producing lithium zirconium phosphate by means of flame spray pyrolysis using as precursors lithium, phosphorous and zirconium compounds. The therein described processes are suited to produce lithium zirconium phosphate with acceptable optical properties but the throughput is limited in case the desired product shall be as white as possible. Using higher values for the flow-rates of the introduced gas streams into the flame pyrolysis lead to grey products that are not suited for industrial applications The grey properties results from incomplete combustion of the precursors and is attributed to carbon residuals in the product. Especially due to the increasing demand for electronic and energy storing devices, materials with optimized properties that can be obtained in industrial scales with high throughput, are much more requested.

A promising material that also can be used in batteries is zirconium phosphate. K. Min et al., describe in Sci Rep. 2017; 7:7151, Li reactive coating with metal phosphate. Cobalt phosphate, manganese phosphate and iron phosphate seems to be good coating materials at interface at cathode active material for Li reactive coating.

US2007/0224483A1 describes the preparation of precursor organic solutions of tetravalent metal phosphates and pyrophosphates for different metals. An important property of these solutions is that the said compounds are formed when the solvent is evaporated, allowing an insertion of the compounds inside the pores of porous membranes, in polymeric membranes and in the electrodic interfaces of fuel cells.

Furthermore, common strategies described in literature to obtain a zirconium pyrophosphate coated cathode material require laborious wet chemical processes with long-lasting reaction time, subsequent drying and calcination steps at high temperatures. Such a method for the wet chemical production of zirconium pyrophosphate is described by Maati Houda et. al, in Catalysis Letters, vol. 148, no. 2, pages 699-711, (Nanostructured Zirconium pyrophosphate catalyzed diastereoselective synthesis of [beta]-Amino ketones via One-Pot Three-Component Mannich Reaction).

Such wet chemical processes lead to powders of zirconium pyrophosphate with a broad particle size distribution and an unfavorable tamped density. Especially for the use in electrodes and batteries, a specific property profile is needed, that cannot be covered by wet chemically produced materials. Wet chemically produced materials usually have denser aggregates, resulting in a poor dispersibility which cause an unbeneficial inhomogeneous coating of these materials on electrodes of batteries.

Therefore, these processes are not only time consuming and costly, but also do not provide materials for the usage in batteries, making these processes rather unsuitable for industrial application.

### Problem and Solution

The problem addressed by the present invention is to provide an improved method for industrial manufacturing of nanosized and a nanostructured zirconium phosphate that can be easily used in batteries.

Specifically, this method should provide zirconium phosphate particles with relatively small particle size, high BET surface area and low tamped density.

Spray pyrolysis is a known method for producing various metal oxides and particular metal salts.

In spray pyrolysis, metal compounds in the form of fine droplets are introduced into a high-temperature zone where they are oxidized and/or hydrolysed to give the corresponding metal oxides or salts. A special form of this process is that of flame spray pyrolysis, in which the droplets are supplied to a flame which is formed by ignition of a fuel gas and an oxygen-containing gas.

In the course of experimentation, it was surprisingly found that zirconium phosphates with the desired particle properties can be directly prepared by means of the flame spray pyrolysis method when using a special combination of precursors and the solvents. Nanostructured zirconium pyrophosphate made by flame process, thus pyrogenically prepared, reveals a mono-modally and narrow particle size distribution in combination with an excellent dispersibility during dry coating process. This leads to a complete de-agglomeration of the zirconium pyrophosphate aggregates and finally enables the formation of the fully and homogenous zirconium pyrophosphate coating layer around lithium-mixed oxide cathode particles made by dry coating of the powders. This high-intensity dry coating approach is very time efficient. In addition, the inventive materials show a high affinity to react with residual lithium ion-containing species on the surface of cathode active materials, which would otherwise interfere with the function of the battery. Not to be bound to a theory, it is expected that the lithium ion-containing species will react with the zirconium phosphate to form partially lithium zirconium phosphate, a commonly known battery material.

Zirconium Phosphate The invention provides pyrogenically prepared zirconium phosphate of general formula ZrP₂O₇ characterized in that the zirconium phosphate
is in the form of aggregated primary particles,
has a BET surface area (DIN 9277:2014) of 5 m2/g-100 m^{2/}g,
a numerical mean particle diameter of d₅₀=0.03 μm-2 μm, as determined by static light scattering (SLS), and
a tamped density (DIN ISO 787-11:1995) of 20 g/L-200 g/L.

The inventive zirconium phosphate can be obtained by the process of the invention described below.

The inventive pyrogenically prepared zirconium phosphate has a BET surface area of 5 m2/g-100 m²/g, preferably of 7 m²/g-80 m²/g, more preferably of 15-60 m²/g. The BET surface area can be determined according to DIN 9277:2014 by nitrogen adsorption according to Brunauer-Emmett-Teller procedure.

The inventive pyrogenically prepared zirconium phosphate is in the form of aggregated primary particles with a numerical mean diameter of primary particles of typically 1-100 nm, preferably 3-70 nm, more preferably 5-50 nm, as determined by transition electron microscopy (TEM). This numerical mean diameter can be determined by calculating the average size of at least 500 particles analysed by TEM.

The numerical mean particle diameter of the zirconium phosphate in aggregated and optionally agglomerated form d₅₀ is about 0.03 μm-2 μm, more preferably 0.04 μm-1 μm, even more preferably 0.05 μm-0.5 μm, as determined by static light scattering (SLS) after 300 s of ultrasonic treatment at 25° C. of a mixture consisting of 5% by weight of the particles and 95% by weight of a 0.5 g/L solution of sodium pyrophosphate in water.

The agglomerates and partly the aggregates can be destroyed e.g. by grinding or ultrasonic treatment of the particles to result in particles with a smaller particle size and a narrower particle size distribution.

The pyrogenically prepared zirconium phosphate according to the invention has a tamped density of 20 g/L-200 g/L, preferably 25 g/L-150 g/L, even more preferably 30 g/L-100 g/L, still more preferably 40 g/L-80 g/L. Tamped density of a pulverulent or coarse-grain granular material can be determined according to DIN ISO 787-11:1995 “General methods of test for pigments and extenders—Part 11: Determination of tamped volume and apparent density after tamping”. This involves measuring the apparent density of a bed after agitation and tamping.

### The Process for Producing Zirconium Phosphate

The invention further provides a process for producing the inventive zirconium phosphate by means of flame spray pyrolysis, wherein a solution comprising
at least one zirconium compound selected from carboxylates, wherein each of these zirconium carboxylates contains 5 to 20 carbon atoms,
an organic phosphate,
a solvent containing less than 10% by weight water
   is subjected to flame spray pyrolysis.

During the inventive flame spray pyrolysis process, the solution of a zirconium compound (metal precursor) and a phosphorous source in the form of fine droplets is typically introduced into a flame, which is formed by ignition of a fuel gas and an oxygen-containing gas, where the used metal precursor together with the phosphorous source are oxidized and/or hydrolysed to give the corresponding zirconium phosphate.

This reaction initially forms highly disperse approximately spherical primary particles, which in the further course of the reaction coalesce to form aggregates. The aggregates can then accumulate into agglomerates. In contrast to the agglomerates, which as a rule can be separated into the aggregates relatively easily by introduction of energy, the aggregates are broken down further, if at all, only by intensive introduction of energy.

The produced aggregated compound can be referred to as “fumed” or “pyrogenically produced” zirconium phosphate.

The flame spray pyrolysis process is in general described in WO 2015173114 A1 and elsewhere.

The inventive flame spray pyrolysis process preferably comprises the following steps:
a) the solution of the zirconium compound is atomized to afford an aerosol by means of an atomizer gas,
b) the aerosol is brought to reaction in the reaction space of the reactor with a flame obtained by ignition of a mixture of fuel gas and an oxygen-containing gas to obtain a reaction stream,
c) the reaction stream is cooled and
d) the solid zirconium phosphate is subsequently removed from the reaction stream.

Examples of fuel gases are hydrogen, methane, ethane, natural gas and/or carbon monoxide. It is particularly preferable to employ hydrogen. A fuel gas is employed in particular for embodiments where a high crystallinity of the zirconium phosphate to be produced is desired.

The oxygen-containing gas is generally air or oxygen-enriched air. An oxygen-containing gas is employed in particular for embodiments where for example a high BET surface area of the zirconium phosphate to be produced is desired. The total amount of oxygen is generally chosen such that, it is sufficient at least for complete conversion of the fuel gas and the metal precursor.

For obtaining the aerosol, the vaporized solution containing the metal precursor can be mixed with an atomizer gas, such as nitrogen, air, and/or other gases. The resulting fine droplets of the aerosol preferably have an average droplet size of 1-120 μm, particularly preferably of 30-100 μm. The droplets are typically produced using single-or multi-material nozzles. To increase the solubility of the metal precursors and to attain a suitable viscosity for atomization of the solution, the solution may be heated.

Metal precursors employed in the inventive process include at least one zirconium carboxylate, each containing 5 to 20 carbon atoms.

The zirconium carboxylates used in the process according to the invention may be a linear, branched or cyclic pentanoate (C5), hexanoate (C6), heptanoate (C7), octanoate (C8), nonanoate (C9), decanoate (D10), undecanoate (C11), dodecanoate (C12), tridecanoate (C13), tetradecanoate (C14), pentadecanoate (C15), hexadecanoate (C16), heptadecanoate (C17), octadecanoate (C18), nonadecanoate (C19), icosanoate (C20) of lithium and/or zirconium, and the mixtures thereof. Most preferably, zirconium 2-ethylhexanoate (C8) is used.

The used metal precursors may contain other salts of zirconium such as nitrates, carbonates, chlorides, bromides, or other organic metal compounds, such as alkoxides, e.g. ethoxides, n-propoxides, isopropoxides, n-butoxides and/or tert-butoxides.

The term “organic phosphate” in the context of the present invention relates to any compound having at least one group (R) containing at least one carbon atom bound to the phosphorus atom of the unit P(═O) via an oxygen atom, e.g. a compound of a general formula (RO)₃P(═O) or (RO)(P(═O))₂, wherein R is a group containing at least one carbon atom, e.g. methyl or ethyl.

The organic phosphate used in the inventive process is preferably selected from esters of phosphonic acid (H₃PO₃), orthophosphoric acid (H₃PO₄), metaphosphoric acid (HPO₃), pyrophosphoric acid (H₄P₂O₇), polyphosphoric acids, and mixtures thereof.

The organic phosphate can be selected from alkyl esters, such as methyl, ethyl, propyl, butyl, hexyl, aryl esters, such as phenyl, mixed alkyl/aryl esters, and mixture thereof. The organic phosphate is preferably an ester having groups containing 1 to 10 carbon atoms, most preferably alkyl groups containing 1 to 10 carbon atoms.

The use of organic phosphates as phosphorous source surprisingly turned out to be crucial for obtaining small particles of zirconium phosphate with a high BET surface area and low tamped density.

The solvent mixture used in the inventive process can be selected from the group consisting of linear or cyclic, saturated or unsaturated, aliphatic or aromatic hydrocarbons, esters of carboxylic acids, ethers, alcohols, carboxylic acids, and the mixtures thereof.

The solvent mixture used in the present invention contains less than 10% by weight water, preferably less than 5% by weight water, more preferably less than less than 3% by weight water, even more preferably less than 2% by weight water, still more preferably less than 1% by weight water. The low water content precludes the undesired hydrolysis of the zirconium carboxylate in the metal precursor solution.

The total metal content of zirconium in the solution of the metal precursor is preferably 1%-30% by weight, more preferably 2%-20% by weight, even more preferably 3%-15% by weight. Under “total metal content” is understood the total weight proportion of all zirconium contained in the metal precursor in the used solution.

The solvent mixture used for the inventive process may additionally contain a chelating agent, i.e. a compound capable of forming two or more coordination bonds with metal ions. The examples of such chelating agents are e.g. diamines like ethylenediamine, ethylenediaminetetraacetic acid (EDTA) and 1,3-dicarbonyl compounds such as acetyl acetone and alkyl acetyl acetates. Most preferably, acetyl acetone is used as such a chelating agent.

It was observed that in the presence of such chelating agents zirconium compounds show better solubility and no precipitation after a relatively long storage time.

The use of the special combination of the metal precursors, the phosphorus source and the solvent in the inventive process allows ensuring good solubility of all precursors and achieving the desired particle properties of the resulting zirconium phosphate such as small particle size, high BET surface area and low tamped density.

The inventive process can further comprise a step of thermal treatment of the zirconium phosphate produced by means of flame spray pyrolysis. This further thermal treatment is preferably carried out at a temperature of 200° C.-1200° C., more preferably at 250° C.-1100° C., even more preferably at 350° C.-900° C. The thermal treatment according to the inventive process allows obtaining a thermally treated zirconium phosphate with desirable properties, especially the desired crystalline structure.

The inventive process can comprise a further step of milling, preferably ball milling of the thermally treated zirconium phosphate. The ball milling is preferably carried out by ZrO₂ balls, e.g. with a diameter of about 0.5 mm in an appropriate solvent, such as ethanol or isopropanol.

### Use of the Zirconium Phosphate in Lithium Ion Batteries

The invention further provides the use of the zirconium phosphate according to the invention in lithium ion batteries, particularly as a component of a solid-state electrolyte of a lithium ion battery, as an additive in liquid, or gel electrolyte or as a constituent of an electrode of a lithium ion battery.

The invention further provides lithium ion battery comprising the zirconium phosphate according to the invention or the zirconium phosphate obtainable by the inventive process.

The lithium ion battery of the invention can contain an active positive electrode (cathode), an anode, a separator and an electrolyte containing a compound comprising lithium.

The positive electrode (cathode) of the lithium ion battery usually includes a current collector and an active cathode material layer formed on the current collector.

The current collector may be an aluminium foil, copper foil, a nickel foil, a stainless-steel foil, a titanium foil, a polymer substrate coated with a conductive metal, or a combination thereof.

The active positive electrode materials may include materials capable of reversible intercalating/deintercalating lithium ions and are well known in the art. Such active positive electrode materials may include transition metal oxides, such as mixed oxides comprising Ni, Co, Mn, V or other transition metals and optionally lithium. The mixed lithium transition metal oxides used with preference as active positive electrode materials are selected from the group consisting of lithium-cobalt oxide, lithium-manganese oxide, lithium-nickel-cobalt oxides, lithium-nickel-manganese-cobalt oxides (NMC), lithium-nickel-cobalt-aluminium oxides, lithium-nickel-manganese oxides, lithium iron phosphates, lithium manganese oxides, or a mixtures thereof.

The anode of the lithium ion battery may comprise any suitable material, commonly used in the secondary lithium ion batteries, capable of reversible intercalating/deintercalating lithium ions.

Typical examples thereof are carbonaceous materials including crystalline carbon such as natural or artificial graphite in the form of plate-like, flake, spherical or fibrous type graphite; amorphous carbon, such as soft carbon, hard carbon, mesophase pitch carbide, fired coke and the like, or mixtures thereof. In addition, lithium metal, lithium layer, or conversion materials (e.g. Si or Sn) can be used as anode active materials.

The invention further provides electrode, such as cathode or anode for a lithium ion battery comprising the inventive zirconium phosphate. Specifically, zirconium phosphate of the invention can be a dopant or a coating material for the electrode.

In the course of thorough experimentation, it was surprisingly found that pyrogenically produced zirconium phosphate may successfully be used for coating of mixed lithium transition metal oxides, which are applicable as cathodes for the lithium batteries.

The invention thus provides a process for producing a coated mixed lithium transition metal oxide, wherein a mixed lithium transition metal oxide and a pyrogenically produced zirconium phosphate are subjected to dry mixing.

### Dry Mixing

Dry mixing is understood to mean that no liquid is added or used during the mixing process, that is e.g., substantially dry powders are mixed together. However, it is possible that there are trace amounts of moisture or some other than water liquids present in the mixed feedstocks or that these include crystallization water.

Dry mixing process of the present invention has some benefits over a mixing process involving wet coating, e.g. coating with a dispersion containing metal oxides. Such a wet coating process inevitably involves the use of solvents, which must be evaporated after the coating process is completed. Thus, the dry coating process of the invention is simpler and more economical than the wet coating processes known from the prior art. On the other hand, it was found that the dry coating process of the invention also provides a better distribution of the zirconium phosphate particles on the surface of the active material, e.g. the mixed lithium transition metal oxide.

Dry mixing may be performed, for example, in a mixing unit having a specific electrical power of 0.05-1.5 kW per kg of the mixed material.

If the used specific electrical power is less than 0.05 kW per kg of the mixed anode material, this gives an inhomogeneous distribution of the zirconium phosphate on top of the active material particles, which may be not firmly bonded to the core material of the active material particles. A specific electrical power of more than 1.5 kW per kg of the mixed anode material leads to poorer electrochemical properties. In addition, there is the risk that the coating will become brittle and prone to fracture. The nominal electrical power of the mixing unit can vary in a wide range, e.g., from 0.1 kW to 1000 kW. Thus, it is possible to use mixing units on the laboratory scale with a nominal power of 0.1-5 kW or mixing units for the production scale with a nominal electrical power of 10-1000 kW. The nominal electrical power is the nameplate, maximal absolute electrical power of the mixing unit.

The volume of the mixing unit may vary in a wide range. For example, the volume of the mixing unit may range from 0.1 L to 2.5 m³. For example, mixing units on a laboratory scale may have a volume of 0.1-10 L or mixing units for the production scale may have a volume of 0.1-2.5 m³. Preferably, in the process according to the invention, forced action mixers are used in the form of intensive mixers with high-speed mixing tools. It has been found that a speed of the mixing tool of 5-30 m/s, more preferably of 10-25 m/s, gives the best results. Examples of commercially available mixing units which are suitable for the process of the invention include Henschel mixers and Eirich mixers. The Eirich mixers may be, for example, high intensity Eirich mixers. The mixing time may vary and may be preferably from 0.1 to 120 minutes, more preferably from 0.2 to 60 minutes, and most preferably from 0.5 to 10 minutes.

The mixing may be followed by a thermal treatment of the mixture for improved binding of the coating to the active material particles. However, this treatment is optional in the process according to the invention since in this process, the pyrogenically produced and nanostructured zirconium phosphate adheres with sufficient firmness to the active material particles. In case a thermal treatment of the mixture is done, the temperature typically is in the range of 200-1000° C. for up to 48 hours. The thermal treatment can be performed in the presence of different types of gases like for example nitrogen, oxygen or forming gas.

The invention further provides electrolyte for a lithium ion battery comprising the inventive zirconium phosphate.

The electrolyte of the lithium ion battery can be in the liquid, gel or solid form.

The liquid electrolyte of the lithium ion battery may comprise any suitable organic solvent commonly used in the lithium ion batteries, such as anhydrous ethylene carbonate (EC), dimethyl carbonate (DMC), propylene carbonate, methylethyl carbonate, diethyl carbonate, gamma butyrolactone, dimethoxyethane, fluoroethylene carbonate, vinylethylene carbonate, or a mixture thereof.

The gel electrolytes include gelled polymers.

The solid electrolyte of the lithium ion battery may comprise oxides, e.g. lithium metal oxides, sulfides, phosphates, or solid polymers.

The liquid or polymer gel electrolyte of the lithium ion battery usually contains a lithium salt.

Examples of such lithium salts include lithium hexafluorophosphate (LiPF₆), lithium bis 2-(trifluoromethylsulfonyl)imide (LiTFSI), lithium bis (fluorosulfonyl) imide (LiFSI), lithium perchlorate (LiClO₄), lithium tetrafluoroborate (LiBF₄), Li₂SiF₆, lithium triflate, LiN(SO₂CF₂CF₃)₂, lithium nitrate, lithium bis(oxalate)borate, lithium-cyclo-difluoromethane-1,1-bis(sulfonyl)imide, lithium-cyclo-hexafluoropropane-1,1-bis(sulfonyl)imide and mixtures thereof.

The lithium ion battery, especially the one with liquid or gel electrolyte can also comprise a separator, which prevents the direct contact between the two electrodes, which would lead to the internal short circuit.

The material of the separator may comprise a polyolefin resin, a fluorinated polyolefin resin, a polyester resin, a polyacrylonitrile resin, a cellulose resin, a non-woven fabric or a mixture thereof. Preferably, this material comprises a polyolefin resin such as a polyethylene or polypropylene based polymer, a fluorinated resin such as polyvinylidene fluoride polymer or polytetrafluoroethylene, a polyester resin such as polyethylene terephthalate and polybutylene terephthalate, a polyacrylonitrile resin, a cellulose resin, a non-woven fabric or a mixture thereof.

The lithium ion battery according to the invention may comprise a liquid electrolyte, a gel electrolyte or a solid electrolyte. The liquid mixture of the lithium salt and the organic solvent, which is not cured, polymerized or cross-linked, is referred to as “liquid electrolyte” in the context of the present invention. The gel or solid mixture comprising a cured, polymerized or cross-linked compound or their mixtures, optionally a solvent, and the lithium salt is referred to as a “gel electrolyte”. Such gel electrolytes can be prepared by polymerization or cross-linking of a mixture, containing at least one reactive, i.e. polymerizable or cross-linkable, compound and a lithium salt.

A special type of lithium-ion battery is a lithium-polymer battery, wherein a polymer electrolyte is used instead of a liquid electrolyte. The electrolyte of a similar solid-state battery can also comprise other types of solid electrolytes, such as sulfidic, oxidic solid electrolytes, or mixtures thereof.

The battery of the invention can be a lithium metal battery, such as Li-air, lithium sulphur (Li—S), and other types of lithium metal batteries.

A Li-air battery typically contains a porous carbon cathode and an organic, glass-ceramic or polymer-ceramic type electrolyte.

A Li-sulfur (Li—S) battery usually contains an iron disulfide (FeS₂), an iron sulfide (FeS), a copper sulfide (CuS), a lead sulfide and a copper sulfide (PbS+CuS) cathode.

There are also many other known types of lithium metal batteries such as e.g. lithium-selenium (Li—Se), lithium-manganese dioxide (Li—MnO₂ or Li/Al—MnO₂), lithium-monofluoride (Li—(CF)ₓ), lithium-thionyl chloride (Li—SOCl₂), lithium-sulfuryl chloride (Li—SO₂Cl₂), lithium-sulfur dioxide (Li—SO₂), lithium-iodine (Li—I₂), lithium-silver chromate (Li—Ag₂CrO₄), lithium-vanadium pentoxide (Li—V₂O₅ or Li/Al—V₂O₅), lithium-copper chloride (Li—CuCl₂), lithium copper (II) oxide (Li—CuO), lithium-copper oxyphosphate (Li—Cu₄O(PO₄)₂) and other types.

### BRIEF DESCRIPTION OF THE DRAWINGS

FIG. 1 is a TEM image of zirconium phosphate particles prepared as described in example 1.

FIG. 2 shows XRD patterns of zirconium phosphates prepared as described in example 1.

FIG. 3 is a TEM image of zirconium phosphate particles prepared as described in example 1.

FIG. 4-2 and comparative examples 1-2.

FIG. 4 shows SEM images of NMC dry coated with fumed zirconium phosphate particles
a) backscattered electrons (BSE) image,
b) EDX mapping of Zr,
c) high resolution SEM image.

FIG. 5 shows the cycling performance of uncoated NMC and NMC dry coated with fumed zirconium phosphate particles in lithium ion batteries with liquid electrolyte.

### EXAMPLES

### Example 1

2,97 kg of a solution containing 1337 g of a commercial solution (Octa Solingen® Zirconium 18), containing 18,01 wt. % Zr in the form of zirconium ethyl hexanoate and 982 g of a commercial solution (Alfa Aesar), containing 16.66 wt. % Phosphorous in the form of triethyl phosphate were mixed, resulting in a clear solution. This solution corresponds to a composition of ZrP₂O₇.

An aerosol of 1.25 kg/h of this solution and 5 Nm³/h of air was formed via a two-component nozzle and sprayed into a tubular reaction with a burning flame. The burning gases of the flame consist of 4.3 Nm³/h hydrogen and 25 Nm³/h of air. Additionally, 15 Nm³/h secondary air was used. After the reactor the reaction gases were cooled down and filtered.

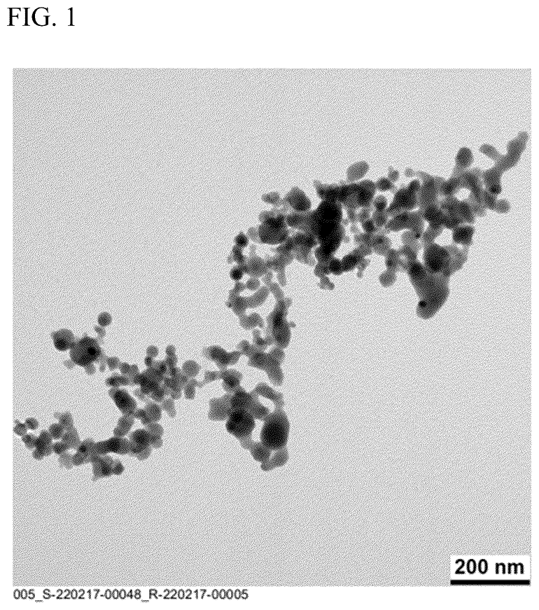

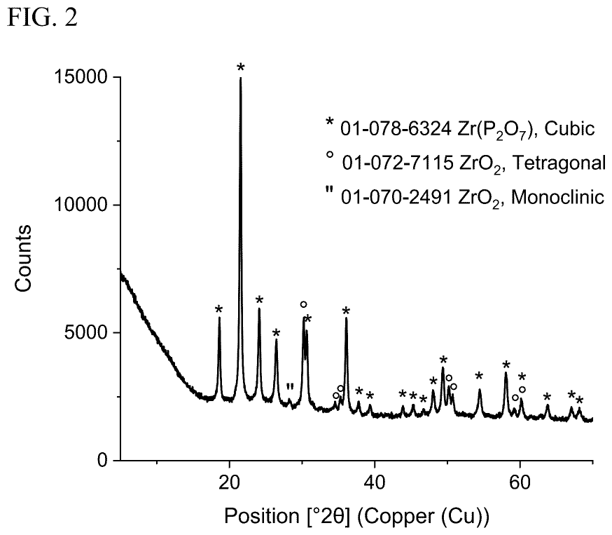

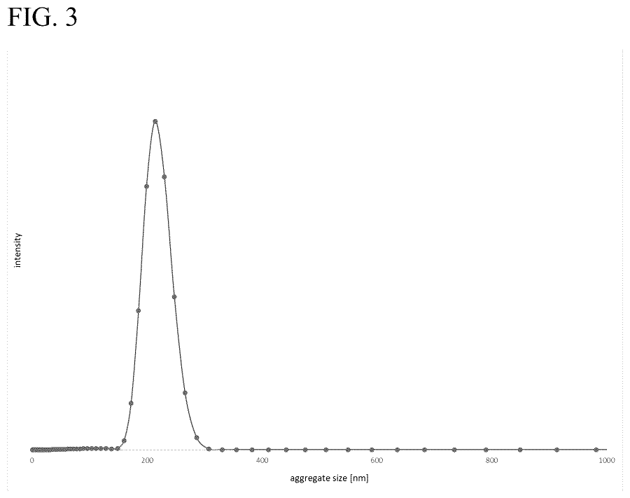

The resulting white powder had a BET surface area of 36 m²/g and a tamped density of 65 g/l. The TEM image of the particles is shown in FIG. 1 and the XRD analysis (FIG. 2) showed, that the major phase of the product was the cubic phase of zirconium phosphate. FIG. 3 shows the aggregate size distribution of this material after 30 min of ultrasonic treatment.

### Example 2

### Dry Coating of Zirconium Phosphate (ZPO) on CAM

The commercial NMC 7 1.5 1.5-powder (Linyi Gelon LIB Co., Type PLB-H7) with a BET surface area of 0.30-0.60 m²/g, medium diameter d50=10,6±2 μm (via laser scattering), was mixed with the respective amount (1.0 wt. %) of ZPO-powder (according to example 1) in a high intensity laboratory mixer (SOMAKON mixer MP-GL with 0.5 L mixing unit) at first for 1 min at 500 rpm to homogeneously mix the two powders. Afterwards the mixing intensity was increased to 2000 rpm for 5 min to achieve the dry coating of the NMC particles by ZPO.

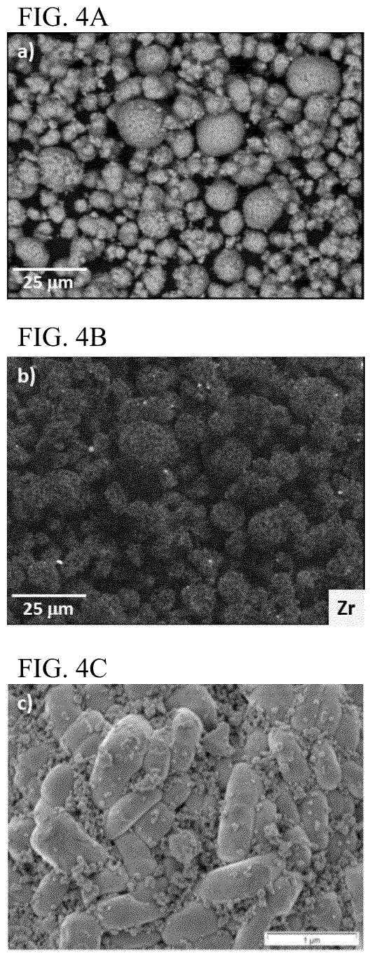

Coated NMC particles are achieved with a ZPO-coating layer thickness of 20-200 nm. FIG. 4 shows SEM-images of NMC dry coated by ZPO. Comparison of the back-scatter electron image (a) and the EDX-mapping of Zr (b) of NMC dry coated by fumed ZPO reveals that a fully and homogeneous coverage around all cathode particles by ZPO was found. No larger ZPO agglomerates were detected, showing that the dispersion of nanostructured fumed ZPO was successful. Additionally, no free unattached ZPO-particles next to the cathode particles were found, indicating the strong adhesion between coating and substrate. The high-resolution SEM image (c) shows a homogeneous distribution of ZPO with a high degree of surface coverage of the CAM.

### Example 3

### Electrochemical Tests

Electrodes for electrochemical measurements were prepared by blending 90 wt. % NMC with 5 wt. % PVDF (Solef PVDF 5130) as a binder and 5 wt. % SUPER C65 (IMERYS) as a conductive additive under inert gas atmosphere. N-Methyl-2-pyrrolidone (NMP) was used as the solvent. The slurry was casted on aluminum foil and dried for 20 min on 120° C. heating plate in air. Afterward, the electrode sheet was dried in a vacuum furnace at 120° C. for 2 h. The area-related cathode loading is adjusted to 2,0±0,1 mAh cm⁻². Circular electrodes with a diameter of 12 mm were punched out, calendered to achieve an electrode density of 3.0 g cm⁻³, and dried again in a vacuum furnace at 120° C. for 12 h to remove any residual water and NMP. For the cycling tests the cells were assembled as CR2032 type coin cells (MTI Corporation) in an argon-filled glovebox (GLOVEBOX SYSTEMTECHNIK GmbH). Lithium metal (ROCKWOOD LITHIUM GmbH) is used as the anode material. Celgard 2500 was used as the separator. 35 μL of a solution of 1 molar LiPF6 in ethylene carbonate and ethyl methyl carbonate (50:50 wt./wt.; SIGMA-ALDRICH) was used as electrolyte. The cells were locked with a crimper (MTI). For electrochemical evaluations galvanostatic cycling was performed between 3.0 and 4.3 V vs Li⁺/Li at 25° C. For the calculation of the capacities and the specific currents, only the mass of the active material was considered and a theoretical capacity of 180 mAh/g of NMC 7 1.5 1.5 is supposed. For the coin half-cells during cycling, the C-rate was increased every four cycles, starting from 0.1/0.1 (Charge/Discharge) to 0.2/0.2, 0.5/0.5, 1.0/1.0 and 1.0/2.0 C. Afterward, the cell was cycled at 1/1 C for long term stability test.

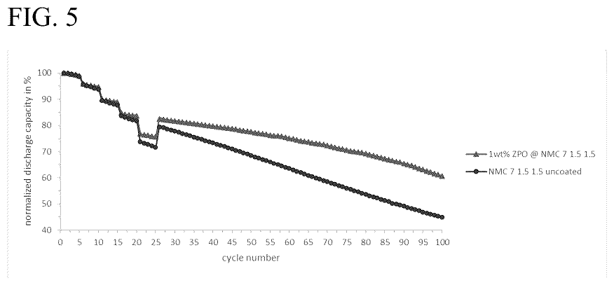

FIG. 5 shows the influence of the received ZPO coating layer on the cycling performance. The performance of NMC coated by fumed ZPO is compared against the uncoated NMC. From the graph data, it can be intuitively concluded that the fumed ZPO coating improves the performance and cycle life of NMC significantly. The NMC coated by fumed ZPO shows an improved rate capability and long-term cycling stability.

Measurement of LiOH and Li₂CO₃ Content

2 g of the cathode material powder and 30 mL deionized water were placed into a 100 mL titration beaker and stirred for 10 minutes at room temperature. The remaining solids were filtered off and the filter was rinsed with 20 mL of deionized water. All the liquids were collected in a 100 mL titration beaker. The LiOH and Li₂CO₃ contents were determined by titration with hydrochloric acid (c(HCl)=0.1 mol/L) using Tris(hydroxymethyl)aminomethane (TRIS) as standard. Therefore the beaker was put on the manual titration stand (Excellence Titrator T7 with the 20 mL Burette DV1020 and the Electrode DGi111-SC from Mettler Toledo) and titration was started.

For the material of Example 1 0,05 wt. % of LiOH and 0.265 wt. % of Li₂CO₃ were detected by titration. In comparison, 0,168 wt. % of LiOH and 0.511 wt. % of Li₂CO₃ were detected by titration on the uncoated NMC.

As can be seen from the examples the inventive zirconium phosphate (ZPO) is well suited to be used advantageously as a constituent of an electrode. Besides improved performance and cycle life it has also been shown that the inventive material is capable of reducing the LiOH/Li₂CO₃ content thus emphasizing the lithium ion scavenging ability of the inventive zirconium phosphate.

1. A pyrogenically prepared zirconium phosphate of general formula ZrP₂O₇, wherein the pyrogenically prepared zirconium phosphate
is in a form of aggregated primary particles,
has a BET surface area, DIN 9277:2014, of 5 m²/g-100 m²/g,
has a numerical mean particle diameter of d₅₀=0.03 μm-2 μm, as determined by static light scattering (SLS), and
has a tamped density, DIN ISO 787-11:1995; of 20 g/L-200 g/L.

2. A process for producing the pyrogenically prepared zirconium phosphate according to claim 1 by flame spray pyrolysis, the process comprising:
subjecting to flame spray pyrolsis a solution comprising
at least one zirconium carboxylate, wherein the at least one zirconium carboxylate contains 5 to 20 carbon atoms,
an organic phosphate, and
a solvent containing less than 10% by weight water.

3. The process according to claim 2, wherein the at least one zirconium carboxylate is a carboxylate selected from the group consisting of linear, branched or cyclic pentanoate (C5), hexanoate (C6), heptanoate (C7), octanoate (C8), nonanoate (C9), decanoate (D10), undecanoate (C11), dodecanoate (C12), tridecanoate (C13), tetradecanoate (C14), pentadecanoate (C15), hexadecanoate (C16), heprtadecanoate (C17), octadecanoate (C18), nonadecanoate (C19), icosanoate (C20) of zirconium, and mixtures thereof.

4. The process according to claim 2, wherein the organic phosphate is selected from the group consisting of esters of phosphonic acid (H₃PO₃), orthophosphoric acid (H₃PO₄), metaphosphoric acid (HPO₃), pyrophosphoric acid (H₄P₂O₇), polyphosphoric acids, and mixtures thereof.

5. The process according to claim 2, wherein the organic phosphate is selected from the group consisting of alkyl ester, aryl ester, mixed alkyl/aryl esters, and mixtures thereof.

6. The process according to claim 2, wherein the organic phosphate is an alkyl ester having alkyl groups with 1 to 10 carbon atoms.

7. The process according to claim 2, wherein the solvent is selected from the group consisting of linear or cyclic, saturated or unsaturated, aliphatic or aromatic hydrocarbons, esters of carboxylic acids, ethers, alcohols, carboxylic acids, and the mixtures thereof.

8. The process according to claim 2, further comprising:
thermally treating of the pyrogenically prepared zirconium phosphate, produced by flame spray pyrolysis, at a temperature of 600° C.-1300° C.

9. The process according to claim 8, further comprising milling of the thermally treated pyrogenically prepared zirconium phosphate.

10. A component of a solid-state electrolyte, comprising the pyrogenically prepared zirconium phosphate according to claim 1 as an additive in liquid, or gel electrolyte or as a constituent of an electrode of a lithium ion battery.

11. An electrode for a lithium ion battery comprising the pyrogenically prepared zirconium phosphate according to claim 1.

12. An electrolyte for a lithium ion battery comprising the pyrogenically prepared zirconium phosphate according to claim 1.

13. A lithium ion battery comprising the pyrogenically prepared zirconium phosphate according to claim 1.

14. The lithium ion battery according to claim 13, comprising a liquid or gel electrolyte.

15. The lithium ion battery according to claim 14, wherein the lithium ion battery is a solid-state battery.

16. An additive in liquid or gel electrolyte comprising the pyrogenically prepared zirconium phosphate according to claim 1.

17. A constituent of an electrode of a lithium ion battery comprising the pyrogenically prepared zirconium phosphate according to claim 1.
